(19) United States
(12) Patent Application Publication
(10) Pub. No.: US 2007/0091935 A1
(43) Pub. Date: Apr. 26, 2007

(54) Reference clock recovery circuit and data receiving apparatus

(75) Inventors: Takeshi Yonezawa, Kanagawa (JP); Izumi Ooshima, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/580,856

(22) Filed: Oct. 16, 2006

(30) Foreign Application Priority Data
Oct. 25, 2005 (JP) 2005-310343

(51) Int. Cl. H04J 3/06

(52) U.S. Cl. 370/503; 370/401

(57) ABSTRACT

An audio recovery circuit is supplied with a video clock VCK that synchronizes with a video clock of a sending side recovered according to a frame synchronizing signal generated based on an incoming stream. The audio recovery circuit includes a PLL circuit for multiplying and dividing VCK to generate an audio master clock MCK, a counting circuit for counting the number of MCKs in one frame, and a cycle adjusting circuit for generating an audio bit clock BCK from a specified number of MCKs. The cycle adjusting circuit adjusts a cycle of BCK in a unit of MCK so that the number of clocks corresponds with the number of samples, according to the number of audio samples to be sent and the number of current MCK.

### BACKGROUND OF THE INVENTION

1. Field of the Invention

The present invention relates to a reference clock recovery circuit for recovering a reference clock of audio and/or video data included in an incoming stream, for example, and a data receiving apparatus having such reference clock recovery circuit therein.

2. Description of Related Art

Generally a receiving apparatus for receiving video or audio data needs to recover a video or audio clock to process the data. A receiving apparatus for recovering an audio reference clock from a video reference clock is disclosed in Japanese Unexamined Patent Application Publication No. 2004-80557 (Miyamoto), for example.

In the receiving apparatus disclosed in Miyamoto, a frequency of the audio reference clock may differ depending on an audio signal to be transmitted. However this receiving apparatus is to recover an audio clock using a common VCO (Voltage Controlled Oscillator) even in such a case.

Streamed data compressed in MPEG (Moving Picture Experts Group) format includes synchronized video and audio clocks. By multiplying and dividing a signal output from the VCO, phases are compared, and based on the comparison, a control voltage of the VCO is controlled so as to synchronize the video clock with an incoming data. Further, by multiplying and dividing the video clock by PLL, dividing a signal output from the video clock and the VCO, comparing the phases, and controlling a control voltage of the VCO based on the comparison, an audio clock corresponding to a sampling frequency Fs of an audio data included in the incoming data can be recovered.

A receiving apparatus that receives a stream having video and audio clocks not synchronized needs to separately recover the video and audio clocks. In a compression technology of DV (Digital Video: IEC61834), video and audio data is often not synchronized, meaning they are not compressed with the same clocks. Therefore in case a simple PLL (Phase Locked Loop) multiply circuit is used, there could be a difference generated between the number of audio samples, thereby causing an overflow or underflow of a transfer data.

Accordingly generally a circuit for decompressing data that uses DV compression technology requires VCO circuits for video and audio data. FIG. 5 is a block diagram showing an example of a conventional DV decoder. As shown in FIG. 5, the system includes an incoming data processing circuit 111 for receiving an incoming stream and a DV decoder 112 for decoding DV compressed data sent from the incoming data processing circuit 111. The DV decoder 112 is supplied with an audio clock by an audio clock recovery circuit 130 and a video clock by a video clock recovery circuit 120. The DV decoder 112 uses the audio and video clocks to output audio and video data.

The audio clock recovery circuit 130 and video clock recovery circuit 120 have similar configurations. For example the video clock recovery circuit 120 includes a VCO circuit for video clock 121, a clock counter 122, and a phase comparator 123. The VCO circuit for video clock 121 is an oscillator capable of changing an oscillating frequency according to a change in a control voltage. The clock counter 122 is supplied with a frame synchronizing signal of video data included in an incoming stream and a clock output by the VCO circuit for video clock. The clock counter 122 counts the clocks in one frame. The phase comparator 123 compares an ideal number of clocks included in one frame with the number of counted clocks and generates a control signal based on the comparison so as to control a control voltage of the VCO circuit 121.

This is how the video clock recovery circuit 120 recovers a video clock synchronized with a video clock of a receiving side and supplies the video clock to the DV decoder 122. The audio clock recovery circuit 130 recovers an audio clock in the same way.

However the conventional DV decoder 112 shown in FIG. 5 has to input a clock via a PLL circuit (the audio clock recovery circuit 130 and the video clock recovery circuit 120) that both include analog VCO circuits. Accordingly area for the analog circuits is required, thereby increasing the size of an apparatus. This problem also applies to the technique disclosed in Miyamoto. However this problem can be more apparent for DV because two clock recovery circuits are required for audio and video.

### SUMMARY OF THE INVENTION

According to the present invention, there is provided a reference clock recovery circuit that includes a clock counter and a cycle adjusting circuit. The clock counter is supplied with section information indicating a start of a specified section and a clock for recovering a reference clock having higher frequency than a frequency of a reference clock of a sending side used in outputting video/audio data, and counts the number of clocks of the clock for recovering the reference clock included in one section. The cycle adjusting circuit adjusts a cycle of the reference clock based on a comparison between a target value and the number of clocks counted by the clock counter so that the number of clocks of the reference clock matches with the reference clock of the sending side at least in the specified section to recover the reference clock from the clock for recovering the reference clock.

In the present invention, a clock for recovering a reference clock having higher frequency than a reference clock and adjusts a cycle of the reference clock so that the number of clocks of the reference clock included in a section matches with that of the sending side. This enables to recover the reference clock of the receiving side without using VCO.

According to another aspect of the present invention, there is provided a data receiving apparatus that includes a receiving unit for receiving an incoming stream including video/audio data and frame information, a reference clock recovery unit for recovering a reference clock for outputting the video/audio data according to the frame information, and a data outputting unit for synchronizing the video/audio data with the reference clock to output. The reference clock recovery unit comprises a clock counter and a cycle adjusting circuit. The clock counter is supplied with the frame information and a clock for recovering a reference clock having higher frequency than a frequency of a reference clock of a sending side, and counts the number of clocks of the clock for recovering the reference clock included in one frame indicated by the frame information. The a cycle adjusting circuit adjusts a cycle of the reference clock based on a comparison between a target value and the number of clocks counted by the clock counter so that the number of clocks of the reference clock matches with the reference clock of the sending side at least in the frame to recover the reference clock from the clock for recovering the reference clock.

According to another aspect of the present invention, there is provided a data receiving apparatus that includes a multiplying and dividing circuit supplied with a video clock recovered based on frame information extracted from an incoming stream including audio and video data, for multiplying and dividing the video clock to recovery a clock for recovering an audio clock, a clock counter for counting the clock for recovering the audio clock included in one frame indicated by the frame information, a cycle adjusting circuit for outputting the audio clock based on the clock for recovering the audio clock, and an output circuit for synchronizing the audio and the video data included in the incoming stream with the audio clock and a video clock respectively to output the audio and video data. The cycle adjusting circuit adjusts a cycle of a clock so that the number of audio clocks matches with the number of audio samples in one frame based on the number of audio samples included in the incoming stream and a result of the clock count by the clock counter.

In the present invention a video clock is multiplied and divided to generate a clock for recovering an audio clock. Then clocks for recovering audio clock are counted so as to adjust a cycle of the audio clock according to the result of the count and the number of audio samples included in an incoming stream. This enables to match the number of audio clocks in one frame with the number of audio samples. Accordingly without using VCO, the receiving side is able to recover an audio clock capable of preventing losing audio data and buffer underflow as well as seamlessly transmitting audio data.

The present invention provides a clock recovery circuit and a data receiving apparatus having the clock recovery circuit therein that are capable of recovering a clock without using a VCO circuit for clock recovery.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing a receiving system including a DV decoder having a clock recovery circuit according to the present invention;

FIG. 2 is a block diagram showing a detail of the receiving system according to the present invention;

FIGS. 3A and 3B are views explaining a relationship between audio data (PCM) and audio clock (LRCK and BCK);

FIG. 4A is a view explaining a cycle adjusting method of an audio bit clock for 384 fs/64 BCK according to an embodiment of the present invention;

FIG. 4B is a view explaining a cycle adjusting method of an audio bit clock for 384 fs/32 BCK according to an embodiment of the present invention;

FIG. 4C is a view explaining a cycle adjusting method of an audio bit clock for 256 fs/64 BCK according to an embodiment of the present invention;

FIG. 4D is a view explaining a cycle adjusting method of an audio bit clock for 256 fs/32 BCK according to an embodiment of the present invention; and

FIG. 5 is a block diagram showing an example of a conventional DV decoder.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

This embodiment is a DV decoder having a clock recovery circuit capable of recovering an audio clock only by a video clock and seamlessly transmitting audio data in a DV format data transmission, whereby the present invention is applied thereto.

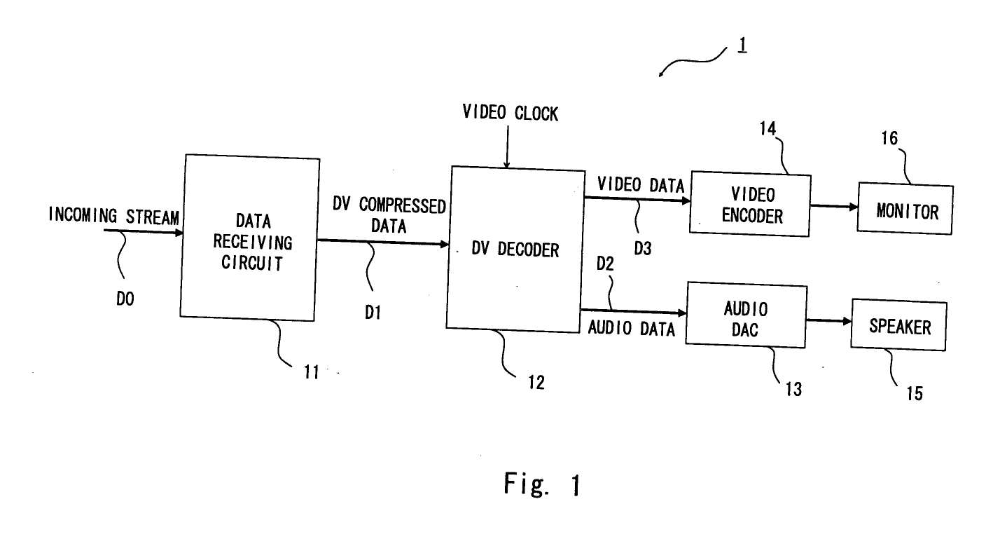

FIG. 1 is a block diagram showing a receiving system with a DV decoder having a clock recovery circuit of this embodiment. As shown in FIG. 1, a receiving system 1 includes a data receiving circuit 11 for receiving a incoming stream DO including DV packets and a DV decoder for receiving a DV compressed data D1 from the data receiving circuit 11.

A video clock is supplied to the DV decoder 12. Then an audio clock is generated based on the video clock, and video data D3 and audio data D2 decompressed by these clocks are output.

The video data is then supplied to a video encoder 14, for example, and converted to analog data to be displayed on a monitor 16. The audio data is converted to analog data by an audio DAC (Digital Analog Converter) 13 and output through a speaker 15.

The DV decoder 12 of this embodiment does not need an audio clock to be supplied unlike a conventional technique. In this embodiment, a PLL is included inside the DV decoder 12 that multiples a video clock to match with a sampling frequency of an incoming DV data and divides the video clock. The divided video clock is referred to an audio master clock MCK. An audio bit clock BCK is generated by dividing the audio master clock MCK. The DV decoder 12 is to control cycles of the bit clock BCK in order to prevent missing audio data in generating the audio bit clock BCK.

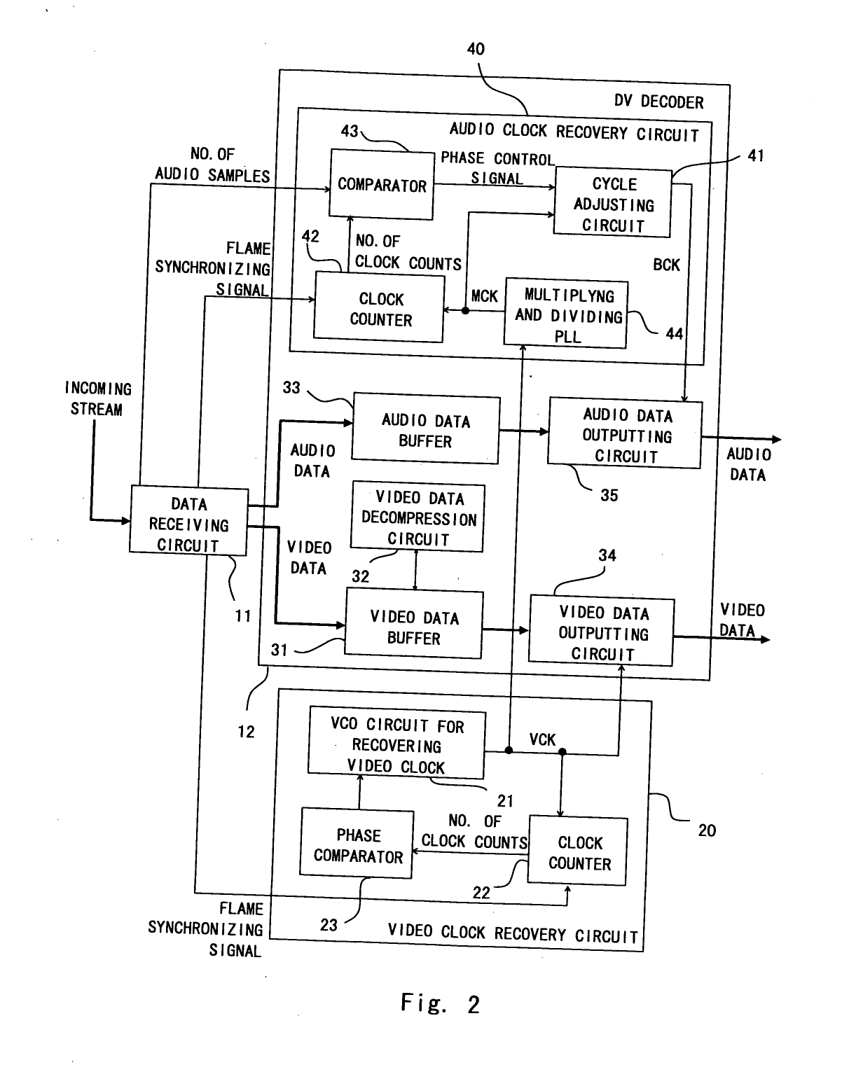

The receiving system 1 is described hereinafter in detail. FIG. 2 is a block diagram showing a detail of the receiving system 1. As shown in FIG. 2, the data receiving circuit 11 receives packetized DV compressed data (DV packet) as an incoming stream. In a NTSC (National Television Standards Committee) format, sync data is added to a header of a DV packet for approximately every 30 Hz. In PAL (Phase Alternation by Line) format, the interval is every 25 Hz. In either format, sync data for synchronization is added in one video frame.

Upon receiving an incoming stream, the data receiving circuit 11 divides the incoming stream into a data part and other part (hereinafter referred to as an additional data part) including header and system information etc. Then the data receiving circuit 11 outputs DV compressed data, which is the data part, to the DV decoder 12. On the other hand the sync data included in the additional data part records time information. The data receiving circuit 11 generates a pulse indicating a start of a frame based on the sync data (the pulse hereinafter referred to as a frame synchronizing signal) for each frame and outputs the pulse to a video clock recovery circuit 20, which is described later in detail. The additional data further includes information such as the number of audio samples included in one frame. The number of audio samples along with the frame synchronizing signal is supplied to the audio clock recovery circuit 40.

The video clock recovery circuit 20 recovers a video clock that is synchronized with a video clock of a receiving end from the incoming stream to supply the video clock to the DV decoder 12. The DV decoder 12 includes the audio clock recovery circuit 40 for recovering an audio clock from the video clock. The DV decoder 12 outputs audio data and decompressed video data based on the audio and video clocks respectively.

The video clock recovery circuit 20 includes a VCO circuit for recovering video clock 21, a clock counter 22, and a phase comparator 23. The VCO circuit for recovering video clock is an oscillator capable of changing an oscillating frequency according to a change in a control voltage and outputting a clock having a specified frequency.

The clock counter 22 is supplied with the abovementioned frame synchronizing signal generated from the header information of a DV packet included in the incoming stream. The clock counter 22 counts the number of clocks generated by the VCO circuit for video clock 21 in one frame. Then the number of video clocks is sent to the phase comparator 23.

An ideal number of video clocks in one frame (1/29.97≈33.3 msex) in NTSC format (29.97 MHz) is approximately 900900 (frequency: 27 MMz). This number of clocks is hereinafter referred to as a target number of clocks. The phase comparator 23 takes the target number of clocks as a target value to compare the number of clocks counted by the clock counter 22 with the target value so as to measure a difference between them. The target value is therefore an ideal value of the video clocks of a sending side that is previously specified for a frame, a unit for recovery. Then the phase comparator 23 generates a PWM (Pulse Width Modulation) signal based on the difference to finely adjust a voltage to be applied to the VCO circuit for video clock 21. The PWM signal controls a clock cycle generated by the VCO circuit for video clock 21 so as to generate a video clock VCK synchronized with a video clock of the sending side.

The video clock VCK of the sending side is also generated by a similar VCO circuit. However frequency of a clock differs depending on the VCO circuit even though a similar control is applied thereto. Further, in case data recorded to a cassette tape, for example is read out and sent, a frame interval may misalign due to expansion and contraction of the tape. The misalign between frame intervals of the sending and receiving sides leads to keep receiving packets with misaligned intervals, causing a receiving side buffer to overflow and lose packet, or underflow to disable outputting data. To avoid such problems, the DV decoder 12 usually includes the video clock recovery circuit 20, eliminates the misalign by the clock counter 22 and the phase comparator 23, and recover the video clock VCK that is synchronized with a video clock of the sending side from the incoming stream.

The DV decoder 12 includes a video data buffer 31, a video data decompressing circuit 32, a video data outputting circuit 34, an audio data buffer 33, and an audio data outputting circuit 35. Further, the DV decoder 12 of this embodiment includes an audio clock recovery circuit 40 for recovering an audio clock from a video clock.

Video data is supplied to the video data buffer 31 and audio data is supplied to the audio data buffer 33 from the abovementioned data receiving circuit 11. The video data is sorted to an appropriate order by the video data buffer 31 and decompressed by the video data decompressing circuit 32. The video data along with the video clock from the video clock recovery circuit 20 is supplied to the video data outputting circuit 34 and the video data is synchronized with the video clock to be output.

The audio data is sorted in an appropriate order by the audio data buffer 35 and supplied to the audio data outputting circuit 35. The audio data outputting circuit 35 is supplied with an audio bit clock (BCK) described later in detail to be used to output the audio data.

The audio clock recovery circuit 40 is described hereinafter in detail. The audio clock recovery circuit 40 of this embodiment is a circuit to recover an audio bit clock based on a video clock.

The audio clock recovery circuit 40 includes a cycle adjusting circuit 41, a clock counter 42, a comparator 43, and a multiplying and dividing PLL 44. The multiplying and dividing PLL 44 is a circuit for multiplying and dividing an incoming clock. In this embodiment, a video clock is input to the multiplying and dividing PLL 44 to be multiplied and divided so as to generate an audio master clock MCK. The audio master clock MCK is a reference clock that various clocks for controlling audio data base thereon.

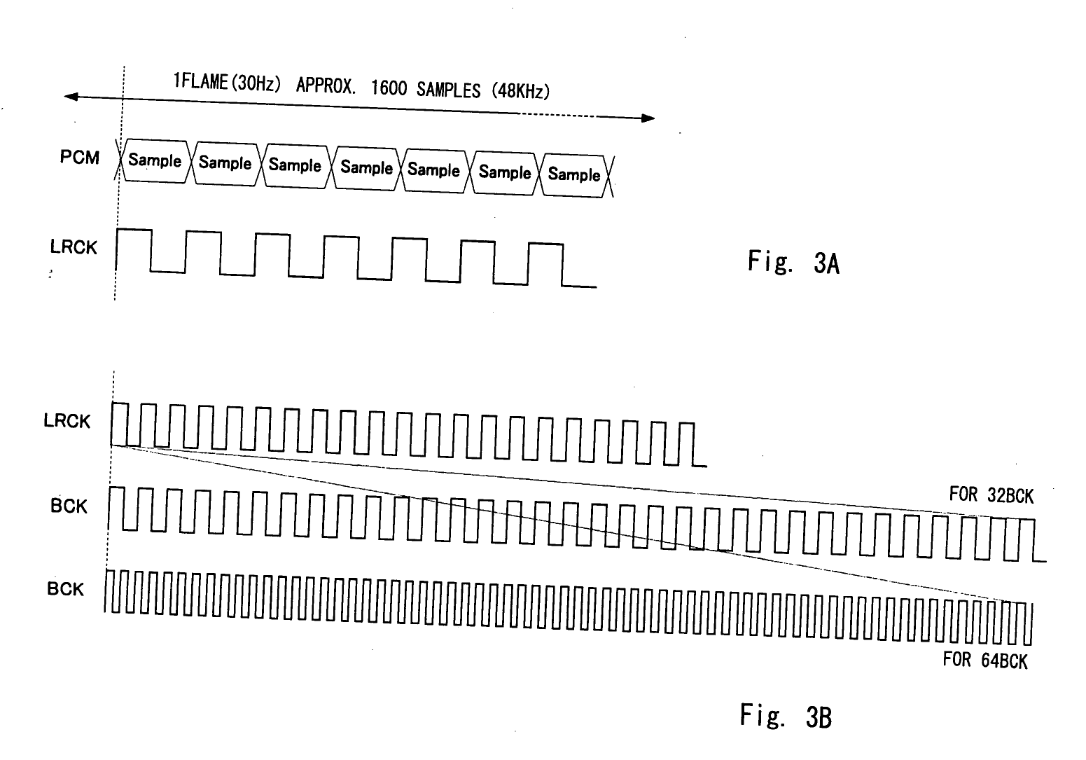

In the explanation below, a sampling frequency fs of audio data is assumed to be 48 kHz. In this case, the number of audio samples in one frame (29.97 MHz) is approximately 1601. There is a plurality of frequencies for the audio master clock MCK for reproducing audio data. FIG. 3 is a pattern diagram showing audio data (PCM) and a clock. FIG. 3 shows one sample represented by 256 audio master clocks MCK. This means that in case a sampling frequency is fs, a frequency of the audio master clock MCK=256×fs. This is referred to as 256 fs hereinafter. Further, in case one audio sample is represented by 384 audio master clocks MCK is referred to as 384 fs. An audio sample may be represented by other number of audio master clocks MCK, for example 512.

In this embodiment, the number of bits of one audio sample is assumed to be 32 or 64. A case of representing one audio sample by 256 audio master clocks MCK and 32 bits (32 audio bit clocks BCK) is referred to as 256 fs/32 BCK hereinafter. Further, a case of representing one sample by 64 bits (64 audio bit clocks BCK) is referred to as 256 fs/64 BCK. Similarly a case of representing one audio sample by 384 audio master clocks MCK and 32 bits (32 audio bit clocks BCK) is referred to as 384 fs/32 BCK. Further a case of representing one sample by 64 bits (64 audio bit clocks BCK) is referred to as 384 fs/64 BCK.

As shown in FIG. 3A, one sample corresponds left and right clock LRCK. For 256 fs or 384 fs/32 BCK, one left and right clock LRCK=32 audio bit clocks BCK, as shown in FIG. 3B. The left and right clock LRCK has high and low comprised of 16 audio bit clocks BCK. As audio data is synchronized with an audio bit clock BCK to be output, left or right sound is represented by 16 bits each. Further, for 256 fs or 384 fs/64 BCK, one LRCK is comprised of 64 audio bit clocks BCK. With left and right sound represented by 32 bits each. The left and right clock LRCK and audio bit clock BCK is generated by multiplying the audio mater clock MCK.

As described in the foregoing, a frequency of the audio master clock MCK varies to 256 fs or 384 fs, for example. Further, representation of one sample by the number of bits also varies. These are specified externally by a user. The multiplying and dividing PLL 44 multiples and divides the video clock VCK to generate the audio master clock MCK having a desired frequency. The generated audio master clock MCK is supplied to the clock counter 42 and the cycle adjusting circuit 41.

The clock counter 42 is supplied with a frame synchronizing signal from the data receiving circuit 11 as with the video clock recovery circuit 20 and counts audio master clock MCK in one frame. Then the number of clock counts is input to the comparator 43.

The comparator 43 is supplied with the number of audio samples of a sending side extracted by the data receiving circuit 11 from system information included in a DV packet. As described in the foregoing, in case the sampling frequency fs is assumed to be 48 kHz, an ideal number of audio samples in one frame (29.97 Hz) is approximately 1601. This could differ depending on a clock frequency of a sending side. Accordingly the sending side sends the number of audio samples in a current frame as system information. The comparator 43 receives the system information, calculates the audio master clock MCK from the number of audio samples, sets the calculates value as a target value, and compares the number of clock counts of the clock counter 42 with the target value. Accordingly the target value is the number of audio master clocks MCK in one frame of the sending side counted in the sending side. For 256 fs/32 BCK, the number of audio samples being input is multiplied by 256, and the calculated value is compared with the number of clock counts of the clock counter 42. A control signal based on the comparison is input to the cycle adjusting circuit 41.

In case the number of audio master clocks MCK is less than the number of clocks corresponding to the number of audio samples, the audio buffer 33 overflows. In such a case, the cycle adjusting circuit 41 controls to shorten a cycle of the audio bit clock BCK. On the other hand in case the number of audio master clocks MCK is larger, the audio buffer 33 underflows. In such a case, the cycle adjusting circuit 41 controls to extend the cycle of the audio bit clock BCK. This is how the cycle adjusting circuit 41 generates the audio bit clock BCK to match with the number of clocks indicated by the number of audio samples sent from the sending side.

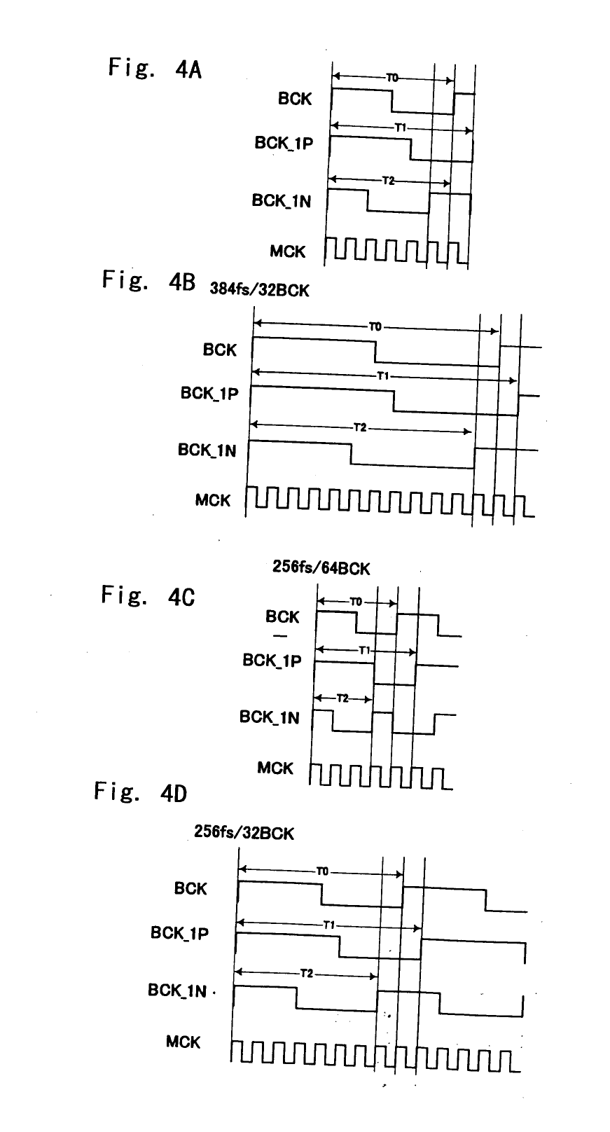

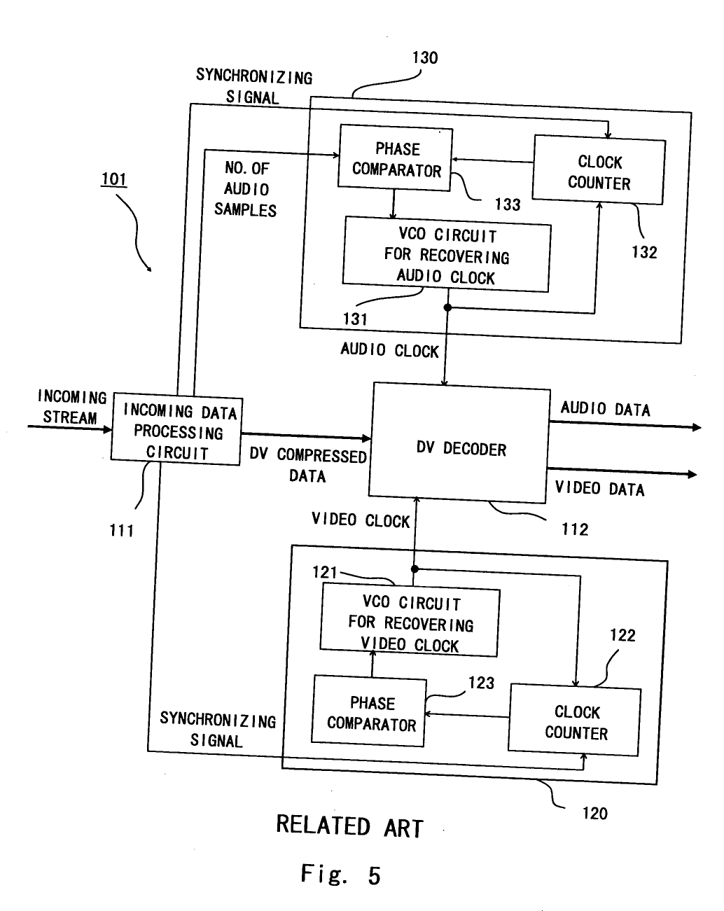

A method of adjusting a cycle by the cycle adjusting circuit 41 is described hereinafter in detail. FIGS. 4A to 4D are views explaining the cycle adjusting method. FIGS. 4A to 4D show 384 fs/64 BCK, 384 fs/32 BCK, 256 fs/64 BCK, and 256 fs/32 BCK, respectively.

As shown in FIG. 4A, for 384 fs/64 BCK, generally one audio bit clock BCK is comprised of 6 audio master clocks MCK with a cycle of T0. The audio bit clock BCK is 64 clocks and one left and right clock LRCK. For example in case a result of a comparison between the number of clock counts and the number of clocks corresponding the number of audio samples performed by the comparator 43 is:
The number of clock counts in one frame>The number of audio samples×384,
specifically in case the audio master clock MCK is faster than the sending side, the number of audio samples will not be enough. To avoid this, the audio bit clock is changed to BCK_1P having a cycle of T1. To be specific, a waveform is changed so that one audio bit clock is comprised of 7 audio master clocks MCK whereas normally one audio bit clock is comprised of 6 audio master clocks MCK. In this example, a period of high is extended to have 4 audio master clocks MCK. It is also possible to extend one cycle of one audio bit clock by making a period of low to have 4 audio master clocks MCK.

A case where the number of samples becomes insufficient for one frame is described hereinafter in detail. In such a case, a frame can be extended for one sample, which is 384 MCK (64 BCK×6). Accordingly for example in case the number of samples is 1601, one frame is comprised of 1601 (samples)×64 BCK simply. Thus by making the audio bit clock BCK to BCK_1P once in approximately 267 BCK, a period of one frame can be extended for one sample. The cycle adjusting circuit 41 receives a comparison result of the comparator 43, determines the interval of making the audio bit clock BCK to be BCK_1P, and generates BCK_1P, so as to control the number of clocks to match with the number of audio samples×384. It is preferable to insert the audio bit clock BCK_1P to have equal number of BCK_1P in one frame.

Conversely in case the audio master clock MCK has:
The number of clock counts in one frame<The number of audio samples×384,
specifically the audio master clock MCK is slower than the sending side, the audio samples will be lost. To avoid this, the audio bit clock is changed to BCK_1N having a cycle of T2. To be specific, a waveform is changed to comprise one audio bit clock by 5 audio master clocks MCK whereas normally one audio bit clock is comprised of 6 audio master clocks MCK. In this example, a period of high is shortened to 2 audio master clocks MCK. It is possible to shorten a cycle of one audio bit clock by changing a period of low to 2 audio master clocks MCK. Inserting the BCK_1N in a specified timing enables to match the number of audio master clocks MCK included in one frame with the number of audio samples×384.

Further in case the number of clock counts=the number of audio samples×384, a cycle of the audio bit clock BCK needs not to be adjusted. As described in the foregoing, in an adjustment of a cycle, clocks of sending and receiving sides may not match due to a transformation of a recording medium of the sending side at a start of data receiving and also while receiving data. Accordingly it is preferable that the number of clocks is compared in every frame to adjust the cycle.

This applies to FIGS. 4B to 4D. For FIG. 4B of 384 fs/32 BCK, one audio bit clock BCK is comprised of 12 audio master clocks MCK. The number of clock counts is matched with the number of audio samples×384 by making it 13 audio master clocks MCK or 11 audio master clocks MCK.

For 256 fs, one sample 256 is comprised of audio master clocks MCK. For 256 fs/64 BCK of FIG. 4C, one audio bit clock BCK is comprised of 4 audio master clocks MCK. The cycle of the audio bit clock BCK is changed by making one audio bit clock BCK to include 5 audio master clocks MCK or 3 audio master clocks MCK. Further, for 245 fs/32 BCK of FIG. 4D, one audio bit clock BCK is comprised of 8 audio master clocks MCK. The cycle of the audio bit clock BCK is changed by making one audio bit clock BCK to include 9 audio master clocks MCK or 7 audio master clocks MCK. The number of clock counts and the number of audio samples×256 can be matched in this way.

The control method of the cycle adjusting circuit 41 is not limited to this but may be other method as long as it is capable of controlling the generation of the left and right clock LRCK to match with the number of samples sent from the sending side. In the above example, one audio master clock MCK is added or deleted to/from the audio bit clock BCK and BCK_1P or BCK_1N is generated to control. There is other method, for example as described hereinafter. That is, LRCK16 for 16 left and right clocks LRCK and LRCK256 for 256 clocks are generated to control the number of clock counts to match with the number of samples. Specifically, for 256 fs/32 BCK, in case an adjustment for ±MCK is performed for every 1 LRCK (=256 MCK), at a LRCK256 (=256×256 MCK), LRCK256 having a cycle of ±4096 (256×16) ways can be obtained. Appropriately combining the LRCK256 having a cycle of ±4096 ways enables to control with higher accuracy.

In such a case, a difference in the number of counts from a comparison result and an association of the combination of the LRCK256 having a cycle of ±4096 ways in one frame are previously specified and may be stored to a table. It is also possible that based on the difference in the number of counts from the comparison result, an appropriate clock combination is read out from the table so as to control the number of left and right clocks LRCK in one frame to match with the number of audio samples.

Specifically, the comparator 43 may be formed by register, for example, and a CPU (Central Processing Unit) (not shown) processes to determine a combination of the LRCK256 having ±4096 ways based on the number of audio samples and the number of clock counts. Then a value to select the LRCK256 having a specified cycle is set to the comparator 43. The comparator 43 outputs the register value being set to the cycle adjusting circuit 41 as a control signal. By the cycle adjusting circuit 41 generating the LRCK256 having an appropriate cycle based on the control signal (register value), the number of left and right clocks LRCK and the number of audio samples in one frame can be matched.

In this embodiment, by using an audio master clock MCK that synchronizes with all audio clocks to be a reference clock having a highest frequency, a cycle of the audio bit clock BCK is adjusted to be longer or shorter for one audio master clock MCK, to have the audio bit clock BCK capable of outputting audio data that matches with the number of audio samples sent from the sending side.

Accordingly adjusting the cycle of the audio bit clock BCK by the audio master clock MCK eliminates the need for analog VCO circuit and enables to process an audio clock digitally. Thus an analog audio clock recovery circuit for supplying an audio clock to a DV decoder is no longer required and enables to simplify the configuration of DV decoder 12.

The present invention is not limited to the abovementioned embodiment and it may be modified and changed without departing from the scope and spirit of the invention. In this embodiment, an example of having only one clock recovery circuit for a video recovery circuit whereby conventionally clock recovery circuits are separately required for audio and video, and an example whereby audio clock is processed digitally have been explained. However a video clock. VCK not only an audio clock may also be digitalized. In this case, a video clock to be synchronized with a video clock of a sending side can be recovered by preparing a clock having a severalfold faster frequency than the video clock and shortening or extending a cycle of the video clock by the abovementioned method.

Further in this embodiment, an example of adjusting the audio bit clock BCK of the receiving side by the audio master clock MCK of the receiving side is explained, so that the number of audio bit clocks in one frame of the sending side matches with the number of audio bit clocks BCK in one frame of the receiving side. However the interval of the adjustment is not limited to one frame but may be less or more than one frame.

A case of incorporating this embodiment to a clock recovery circuit of a DV decoder is explained here, however it maybe applied to other codecs. That is, a clock having a severalfold faster frequency than a reference clock desiring to generate can be prepared so as to generate a reference clock having a desired cycle.

The processes of the blocks in the abovementioned embodiment may be realized by hardware configuration for example by a CPU executing computer programs. In this case, the computer programs may be recorded in a recording medium or transmitted via other transmission media such as internet.

It is apparent that the present invention is not limited to the above embodiment and it may be modified and changed without departing from the scope and spirit of the invention.

What is claimed is:

1. A reference clock recovery circuit comprising:
a clock counter supplied with section information indicating a start of a specified section and a clock for recovering a reference clock having higher frequency than a frequency of a reference clock of a sending side used in outputting video/audio data, for counting the number of clocks of the clock for recovering the reference clock included in one section; and
a cycle adjusting circuit for adjusting a cycle of the reference clock based on a comparison between a target value and the number of clocks counted by the clock counter so that the number of clocks of the reference clock matches with the reference clock of the sending side at least in the specified section to recover the reference clock from the clock for recovering the reference clock.

2. The reference clock recovery circuit according to claim 1, wherein the reference clock is to reproduce video data sent with frame information in a packet as the section information.

3. The reference clock recovery circuit according to claim 1, wherein the reference clock is to reproduce audio data sent with frame information in a packet as the section information.

4. The reference clock recovery circuit according to claim 3, wherein the packet includes the frame information, and audio and video data, and generates the clock for recovering the reference clock according to a recovered video clock.

5. The reference clock recovery circuit according to claim 4, wherein the video clock is a clock having a frequency controlled to include a specified number of clocks for recovering a video clock oscillated by a voltage-controlled oscillator in one frame indicated by the frame information, and
the reference clock recovery circuit includes a multiplying and dividing circuit for multiplying and dividing the video clock to generate the clock for recovering the reference clock.

6. The reference clock recovery circuit according to claim 3, wherein the target value is calculated according to the number of audio samples included in the packet.

7. The reference clock recovery circuit according to claim 2, wherein the cycle adjusting circuit compares the number of target clocks, a target value of the clock for recovering the reference clock calculated from the number of audio samples, with the number of clocks, adjusts the cycle of the reference clock to be longer in case the number of clocks is larger, and adjusts the cycle of the reference clock to be shorter in case the number of count clocks is smaller.

8. The reference clock recovery circuit according to claim 1, wherein the cycle adjusting circuit adjusts a cycle of the reference clock by a unit of the clock for recovering the reference clock based on the comparison.

9. A data receiving apparatus comprising:
a receiving unit for receiving an incoming stream including video/audio data and frame information;
a reference clock recovery unit for recovering a reference clock for outputting the video/audio data according to the frame information; and
a data outputting unit for synchronizing the video/audio data with the reference clock to output,
wherein the reference clock recovery unit comprises:
a clock counter supplied with the frame information and a clock for recovering a reference clock having higher frequency than a frequency of a reference clock of a sending side, for counting the number of clocks of the clock for recovering the reference clock included in one frame indicated by the frame information; and
a cycle adjusting circuit for adjusting a cycle of the reference clock based on a comparison between a target value and the number of clocks counted by the clock counter so that the number of clocks of the reference clock matches with the reference clock of the sending side at least in the frame to recover the reference clock from the clock for recovering the reference clock.

10. A data receiving apparatus comprising:
a multiplying and dividing circuit supplied with a video clock recovered based on frame information extracted from an incoming stream including audio and video data, for multiplying and dividing the video clock to recovery a clock for recovering an audio clock;
a clock counter for counting the clock for recovering the audio clock included in one frame indicated by the frame information;
a cycle adjusting circuit for outputting the audio clock based on the clock for recovering the audio clock; and
an output circuit for synchronizing the audio and the video data included in the incoming stream with the audio clock and a video clock respectively to output the audio and video data,
wherein the cycle adjusting circuit adjusts a cycle of a clock so that the number of audio clocks matches with the number of audio samples in one frame based on the number of audio samples included in the incoming stream and a result of the clock count by the clock counter.

11. The data receiving apparatus according to claim 10, wherein the video clock is a clock having its frequency controlled to include a specified number of clocks for recovering a video clock oscillated by a voltage-controlled oscillator in one frame indicated by the frame information.

12. The data receiving apparatus according to claim 10, wherein the cycle adjusting circuit compares the number of target clocks, a target value of the clock for recovering the reference clock calculated from the number of audio samples, with the number of clocks, adjusts the cycle of the reference clock to be longer in case the number of clocks is larger, and adjusts the cycle of the reference clock to be shorter in case the number of count clocks is smaller.

13. The data receiving apparatus according to claim 10, wherein the cycle adjusting circuit adjusts a cycle of the reference clock by a unit of the clock for recovering the reference clock based on the comparison.
